(19) United States
(12) Patent Application Publication
(10) Pub. No.: US 2023/0406717 A1
(43) Pub. Date: Dec. 21, 2023

(54) PROCESS FOR THE REMOVAL OF FLUORIDE FROM ALKALINE HYDROXIDE SOLUTIONS

(71) Applicant: BASF SE, Ludwigshafen am Rhien (DE)

(72) Inventors: Nils-Olof Joachim Born, Ludwigshafen (DE); Mattia Giacomini, Ludwigshafen (DE); Birgit Gerke, Ludwigshafen (DE); Fabian Seeler, Ludwigshafen (DE); Wolfgang Rohde, Ludwigshafen (DE); Kerstin Schierle-Arndt, Ludwigshafen (DE); Regina Vogelsang, Ludwigshafen (DE)

(21) Appl. No.: 18/037,673

(22) PCT Filed: Nov. 19, 2021
(86) PCT No.: PCT/EP2021/082377

§ 371 Date: May 18, 2023

(30) Foreign Application Priority Data
Nov. 20, 2020 (EP) 20208982.7

(51) Int. Cl. C01D 15/02; B01J 20/04; B01J 20/28; C02F 1/28; C22B 7/00; C22B 3/06; C22B 3/26; H01M 10/54

(52) U.S. Cl. CPC C01D 15/02; B01J 20/043; B01J 20/041; B01J 20/045; B01J 20/048; B01J 20/2803; B01J 20/28016; B01J 20/28004; C02F 1/288; C22B 7/007; C22B 3/06; C22B 3/26; H01M 10/54; C01P 2006/80; C02F 1/281; C02F 2101/14

(57) ABSTRACT

A process for extracting fluoride from a solution of high pH comprising more than 0.1 mol of alkaline hydroxide and/or alcoholate per liter dissolved in a polar solvent is described. The polar solvent is chosen from water, lower alcohols, and mixtures thereof. The process is characterized in that the solution liquid is contacted with a solid phase adsorbent chosen from a) alkaline earth salts comprising carbonate anions, oxo anions, sulphate anions, or phosphate anions, and alkaline earth salts comprising a mixture of such anions or a mixture of such anions with hydroxyl anions, and b) cation binding resins loaded with one or more 3-valent cations, chosen from 3-valent cations of Al, Ga, In, Fe, Cr, Sc, Y, La and lanthanoides.

This application claims the benefit of European Patent Application No. 20208982.7, filed on Nov. 20, 2020, the contents of which are incorporated by reference herein in their entirety.

The project leading to this application has received funding from Bundesministerium für Wirtschaft and Energie (DE; FKZ:16BZF101A); the applicant bears responsibility for all disclosures herein.

The present disclosure is directed towards a process for extracting fluoride from an aqueous alkaline solution of high pH, typically pH 13 or larger; the process is characterized in that the alkaline solution is contacted with a solid phase adsorbent chosen from alkaline earth salts comprising carbonate anions, oxo anions, sulphate anions, phosphate anions, or mixtures of such anions or mixtures of such anions with hydroxyl anions, and from cation binding resins loaded with one or more 3-valent cations. An example application of the present process is the removal of fluoride from solutions of lithium hydroxide obtainable from spent lithium ion batteries.

The removal of fluoride from aqueous solutions frequently becomes necessary in the processing of drinking water. One common process for the defluorination of drinking water at pH ranges near neutral is ion exchange.

An example application of the present process is the recovery of high purity lithium hydroxide from lithium containing resources that also contain fluoride ions. Such resources may be geogenic-like, for example the lithium mineral Lepidolite, or anthropogenic-like waste lithium ion batteries containing at least one transition metal chosen from nickel, manganese and cobalt.

For a typical extraction of lithium from Lepidolite, the mineral is calcined with limestone. From solutions of the material containing lithium hydroxide and lithium fluoride, most lithium fluoride can be removed after concentration and filtration. The resulting filtrate may still contain low amounts of fluoride determined by the solution equilibrium.

A similar situation may occur in the recycling of lithium ion batteries or lithium ion battery materials, where lithium is extracted as lithium hydroxide and/or lithium carbonate; the material and liquid streams thereof typically also contain fluoride. International publication No. WO 2020/011765 describes such extractions inter alia in its examples 2 to 4.

Fluoride containing lithium hydroxide solutions may also result from electrochemical transformations of solutions of lithium salts e.g., lithium chloride or lithium sulfate. Such electrochemical transformations are electrolysis or electrodialysis processes and have also been described in the context of recycling of lithium ion batteries or lithium ion battery materials (WO2014138933, EP2906730).

The alkaline solution treated according to the present disclosure may also result from lithium containing materials like brines, ores, slags, and flue ashes. The amount of fluoride impurities is typically from about 121 ppm or more, e.g., from about 300 ppm or more, or from about 500 ppm or more, such as from 1% or more, from 0.05 to 5%, or from 1.4 to 3.2%, of ionic fluoride, each relative to the total weight of lithium contained, which is dissolved in such liquids. Alkaline salts present include hydroxides and alcoholates. In the case of lithium hydroxide, this may be present in dry form as anhydrate or lithium hydroxide monohydrate. The liquid may contain one or more further impurities from the group of other alkaline salts, aluminum salts, and/or zinc salts. The sum of alkaline, aluminum, and zinc impurities amount to from about 100 to 500 ppm or more, e.g., from about 500 to 10000 ppm, or from about 500 to 5000 ppm, relative to the dry weight of the crude alkaline hydroxide (or alcoholate) solid.

High concentrations of hydroxyl ions, as present at high pH values, are known to displace fluoride from potential bonding sites of adsorbents (see P. Loganathan et al., J. Haz. Mat. 248-249 (2013), e.g., FIG. 1 on page 3 and par. 3.1 on page 4, Loganathan also reports a number of adsorbents active in pH ranges up to 12).

It has now been found that certain adsorbents are surprisingly effective for fluoride removal from high pH solutions. The present disclosure is directed to a process for extracting fluoride from a solution comprising more than 0.1 mol of alkaline hydroxide and/or alcoholate per liter dissolved in a polar solvent, wherein the solution liquid is contacted with a solid phase adsorbent chosen from:
a) alkaline earth salts comprising carbonate anions, oxo anions, sulphate anions, or phosphate anions, and alkaline earth salts comprising a mixture of such anions or a mixture of such anions with hydroxyl anions, and
b) cation binding resins loaded with one or more 3-valent cations, chosen from 3-valent cations of Al, Ga, In, Fe, Cr, Sc, Y, La and lanthanoides.

The polar solvent is chosen from water, lower alcohols, and mixtures thereof. The lower alcohol is chosen from C1-C4 alcohols or is a mixture of such alcohols, such as methanol and/or ethanol. The lower alcohol used as the polar solvent or contained in the polar solvent is a technical product which may contain up to about 6% b.w. of water, the remainder in the product being mainly other alcohols and/or water, while other impurities such as non-alcohol organic solvents may be present up to 1% b.w. of the lower alcohol product or solvent mixture based on such alcohol. The present polar solvent is chosen from water, methanol, ethanol, and mixtures thereof. In some embodiments, a polar solvent comprises at least 50% b.w. of water and/or methanol (each by weight of the total liquid). In some embodiment, the polar solvent comprises 70% b.w. or more of water and/or methanol (each by weight of the total liquid). In some embodiments, the polar solvent comprises 80% b.w. or more of water and/or methanol (each by weight of the total liquid). In some embodiments, the polar solvent comprises 90% b.w. or more of water and/or methanol (each by weight of the total liquid). In some embodiments, the polar solvent comprises 95% b.w. or more of water and/or methanol (each by weight of the total liquid).

The solid phase adsorbent is chosen from:
a) alkaline earth salts comprising calcium phosphates, calcium hydroxyphosphates, calcium sulphate, magnesium carbonate, magnesium oxide, calcium hydroxyapatite and/or tricalcium phosphate, and
b) cation binding resins loaded with one or more 3-valent cations chosen from 3-valent cations of aluminum and lanthanum.

In a process of the present disclosure, a calcium phosphate adsorbent is used. Among the Ca phosphates, two species show significantly improved adsorptivity of fluoride at high pH: Ca hydroxyapatite which has the formal formula Ca₅(PO₄)₃OH and the hydroxyapatite crystal structure (P6₃/m), and tricalcium phosphate which has the formal formula Ca₃(PO₄)₂ and the betatricalcium phosphate structure (R3c h). Both materials are related, as Ca deficient Cahydroxyapatite is converted into the beta-tricalcium phosphate structure at elevated temperatures by releasing one water molecule (Ca_{4.5}(H_{0.5}PO₄)₃OH→1.5 Ca₃(PO₄)₂+H₂O). Therefore, in materials which have been processed at higher temperature, both materials typically are mixed.

From both classes of adsorbents (a) and (b), various types are commercially available. The cation binding ion exchange resins are based on a crosslinked polystyrene matrix with bonding sites of the type —COOH (e.g., functional groups that consists of two carboxylic acid groups —COOH, such as chelating iminodiacetic acid groups) or phosphonic acid groups (C—PO(OH)₂, e.g., attached to a nitrogen atom bonded to the resin's polymer structure, such as chelating aminomethylphosphonic acid groups). The loading with cations can be achieved according to well-known methods.

The dissolved alkaline hydroxide treated in the present process is chosen from hydroxides of lithium, sodium, potassium, cesium, and rubidium. In some embodiments, the alkaline hydroxide is lithium hydroxide, and water or methanol or mixtures thereof are used as the polar solvent. In case of alkaline hydroxides other than lithium hydroxide, the polar solvent comprises mainly water. In case that a lower alcohol is chosen as the polar solvent, the dissolved alkaline species may contain, or even consist of, the alkaline alcoholate, such as lithium, sodium, potassium, cesium, and/or rubidium, and the methanolate. Where the polar solvent is a mixture of water and lower alcohol, the alkaline species may be the alkaline hydroxide.

In some embodiments, the present process is effective for removing dissolved fluoride from solutions of high pH. In some embodiments, the processes treat solutions containing hydroxide and/or alcoholate concentrations greater than 0.1 mol/I; for example, the alkaline hydroxide and/or alcoholate solution contacted with adsorbent (a) or (b) according to the present disclosure may contain, for example, 0.2 mol or more alkaline hydroxide and/or alcoholate per liter of solution, in dissolved state. In some embodiments, the process is used to treat solutions containing 0.35 mol or more alkaline hydroxide and/or alcoholate per liter of solution, in dissolved state. In some embodiments, the process is used to treat solutions containing 0.5 mol or more alkaline hydroxide and/or alcoholate per liter of solution, in dissolved state. In some embodiments, the process is used to treat solutions containing 0.7 mol or more alkaline hydroxide and/or alcoholate per liter of solution, in dissolved state. Examples are solutions containing dissolved lithium hydroxide or lithium methanolate in a concentration from 0.1 to the solubility limit (maximum concentration dissolved), e.g., from 0.1 to 10 mol per liter solution such as from 0.2 to 8 mol per liter, from 0.5 to 6 mol per liter, or from 0.7 to 5.3 mol per liter. In some embodiments, the lithium content in such solutions may range from about 0.2 to about 3.7% by weight of the solution.

The present process may be carried out under various pressure conditions; and compacting of the adsorbent is to be avoided. In some embodiments, operating pressure may, for example, be chosen from 0.1 bar to 100 bar, for example, the operating pressure of the liquid during contact with the adsorbent may be from 0.5 bar to 25 bar, e.g., 0.5 bar to 5 bar.

In some embodiments, while an elevated temperature may be advantageous for the adsorption effect, limitations of the temperature are given by the polar solvent, which should be maintained within its liquid range, and in case that a resin adsorbent (b) is chosen, by the operating temperature range of the resin, which is up to about 85° C. Typical operating temperatures thus are above the melting temperature of the liquid and below the boiling point of the liquid at the operating pressure, e.g., from 0° C. to 150° C. in case of mineral adsorbent (a) orfrom 0° C. to 85° C. in case of resin adsorbent (b).

### BRIEF DESCRIPTION OF THE FIGURES

FIG. 1 shows a diagram of a configuration of a column for fluoride depletion at high pH according to the present disclosure.

FIG. 2 shows a block flow diagram of a lithium leaching process starting from black mass resulting from waste lithium ion batteries (particulate material, PM), with present fluoride depletion process exemplified by the step of F-Adsorption on Apatite.

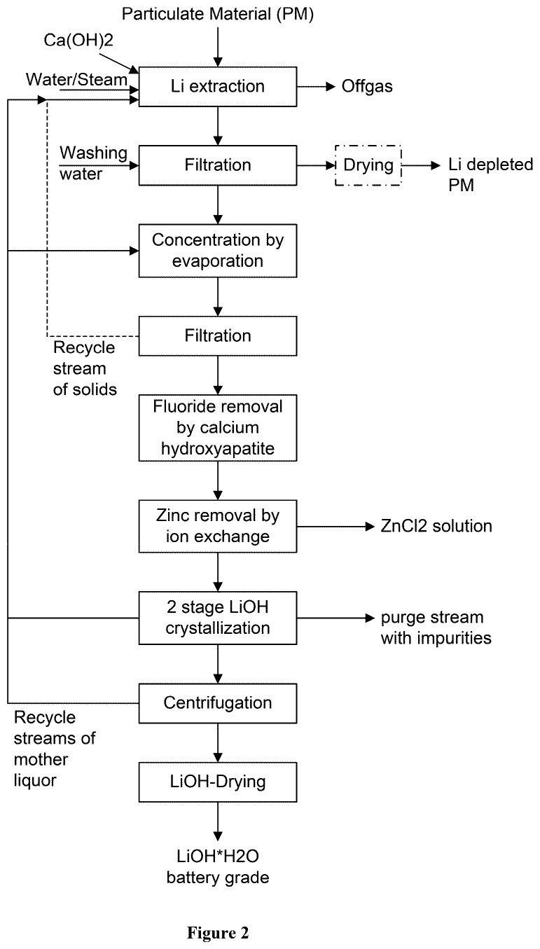

FIG. 3 shows a block flow diagram for another embodiment of a lithium leaching process starting from black mass resulting from waste lithium ion batteries (particulate material, PM), with present fluoride depletion process exemplified by the step of F-Adsorption on Apatite.

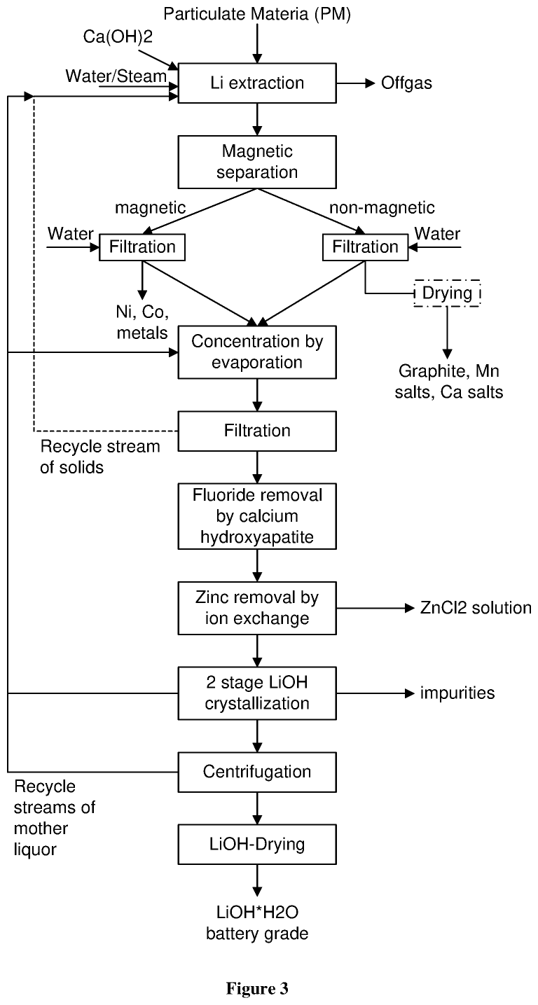

FIG. 4 is an X-ray powder diffractogram (Mo Ka) of reduced mass from waste lithium ion batteries after heat/reduction treatment as obtained in Example 1a and used in educt Example 2a including reference diffractograms of graphite, cobalt, manganese (II)oxide, cobalt oxide, and nickel.

FIG. 5 is an X-ray powder diffractogram (Mo Ka) of reduced mass from waste lithium ion batteries after heat/reduction treatment as obtained in Example 1a and used in educt Example 2a including reference diffractograms of graphite, lithium aluminate, and lithium carbonate.

FIG. 6 is an X-ray powder diffractogram (Cu Ka) of reduced mass from waste lithium ion batteries after heat/reduction treatment as obtained in Example 1a and used in educt Example 2a including reference diffractograms of graphite, cobalt, manganese(II)oxide, cobalt oxide, and nickel.

FIG. 7 is an X-ray powder diffractogram (Cu Ka) of reduced mass from waste lithium ion batteries after heat/reduction treatment as obtained in Example 1a and used in educt Example 2a including reference diffractograms of graphite, lithium aluminate, and lithium carbonate.

FIG. 8 is an X-ray powder diffractogram (Cu Ka) of LiOH monohydrate as obtained in educt Example 5.

### General Definitions

Unless specified otherwise, “contain” in relation to any substance generally means presence of such substance in an amount typically still detectable by x-ray powder diffraction, e.g., 1% by weight or more, or means presence of such constituents in an amount typically detectable by ICP after a suitable digestion, e.g., 10 ppm by weight or more.

The term “about” denotes, with respect to any quantity specified, a potential deviation of up to 5%, especially up to 1% in any direction.

Preparation of LiOH Solution Containing Fluoride from Spent Lithium Ion Batteries

The alkaline solution treated according to the present disclosure may be obtained by carrying out the following process steps:
(A) providing a particulate material (PM) containing a transition metal compound and/or transition metal, wherein the transition metal is chosen from Mn, Ni and Co, and wherein further at least a fraction of the Ni and/or Co, if present, are in an oxidation state lower than +2, such as the metallic state, and at least a fraction of the Mn, if present, is manganese(II)oxide; which particulate material further contains a lithium salt and a fluoride salt; and
(B) treating the material provided in step (A) with a polar solvent, such as an alkaline earth hydroxide; and separating the solids from the liquid, optionally followed by washing the solid residue with a polar solvent such as water. The liquid thus obtained may subsequently be treated according to the present disclosure. Details of such steps (A) and (B) are as follows:

A) Providing a Particulate Material (PM; Reduced Black Mass)

Several authors describe a heat treatment of waste lithium ion batteries or components containing the electrode active materials of these kinds of batteries at elevated temperatures above 400° C. Such a heat treatment results in a complete evaporation of the electrolyte solvents contained in the battery and in a decomposition of polymeric components. The materials obtained from such a heat treatment may be subjected to different mechanical treatments and separation operations to separate out different metal fractions and a powdery substance comprising mainly the electrode active materials from the anode, i.e., graphite and from the cathode, and i.e., a lithium containing transition metal material. These powders are often called “black masses” or “black powders” or “active masses”. In the following disclosure, these powders are described as particulate material (PM). Depending on the reaction conditions, the latter material is often at least partially reduced thus, containing metallic Ni and Co phases, manganese oxide phases, and lithium salts such as LiOH, Li₂CO₃, LiF, LiAlO₂, Li₃PO₄. The reduction takes place by reductive conditions during the heat treatment either by introducing reducing gases like hydrogen (e.g., as provided in International Publication No. WO 2020/011765) or carbon monoxide or at temperatures above 500° C. by the carbonaceous material contained in the waste battery material namely graphite and soot. For example, in the reference J. Li et al., J. Hazard. Mat. 2016, 302, 97 ff, discloses an oxygen-free roasting/wet magnetic separation process for recycling cobalt, lithium carbonate and graphite from spent LiCoO₂/graphite batteries.

B) Lithium Extraction from Particulate Material

Furthermore, International Publication No. WO 2020/011765 discloses that the above-mentioned lithium salts such as LiOH, Li₂CO₃, LiF, LiAlO₂, and Li₃PO₄ can be extracted by treatment of the at least partially reduced product with a polar medium, usually with an aqueous medium. In order to convert the contained lithium species into lithium hydroxide, alkaline earth hydroxides (AEH) are employed. An aqueous medium such as an aqueous solvent or aqueous liquid contains primarily (i.e., by 50% b.w. or more, 80% b.w. or more, or 90% b.w. or more) water. It includes water and mixtures of water with one or more alcohols; and may contain further dissolved substances as long as the major water content is maintained within one or more of the ranges given above.

The lithium hydroxide extraction provides a suspension of the particulate material in the polar solvent. It may be carried out with heating. The treatment with the alkaline earth hydroxide is done at temperatures ranging from about 60° C. to about 200° C., or about 70° C. to about 150° C. Where the boiling point of the polar solvent is exceeded, the treatment is carried out under pressure to hold the solvent, or at least a fraction thereof, in the liquid state. The temperature range is around the boiling point of water, i.e., about 70° C. to 150° C., where the treatment can be achieved using an aqueous liquid or water at normal pressure or slightly elevated pressure (e.g., up to 5 bar). Alternatively, present step (B) can be carried out with application of higher temperatures and pressures, e.g., 150° C. to 300° C. and 1.5 bar to 100 bar.

The treatment is carried out by combining an amount of alkaline earth hydroxide with the particulate material, which corresponds to at least 5%, and not more than 100%, of its weight, e.g., 50-1000 g of AEH on 1 kg of PM, such as 100-1000 g AEH, or 200-1000 g AEH on 1 kg of PM. The amount of polar solvent is chosen to ensure miscibility of the components, e.g., using one part by weight of combined solids (PM and AEH) 0.5 to 95, about 2.5 to 21 parts by weight of the polar solvent; or in certain cases 1 to 20, e.g., about 2 to 10 parts by weight of the polar solvent.

In some embodiments of the present disclosure, the extraction is carried out in a vessel that is protected against strong bases, for example molybdenum and copper rich steel alloys, nickel-based alloys, duplex stainless steel or glass-lined or enamel or titanium coated steel. Further examples are polymer liners and polymer vessels from base-resistant polymers, for example poly-ethylene such as HDPE and UHMPE, fluorinated polyethylene, perfluoroalkoxy alkanes (“PFA”), polytetrafluoroethylene (“PTFE”), PVdF and FEP. FEP stands for fluorinated ethylene propylene polymer, a copolymer from tetrafluoroethylene and hexafluoropropylene.

The treatment is done using a mixing device, e.g., a stirrer, with power application up to 10 W per kg of suspension, e.g., 0.5 to 10 W/kg, and/or cycled by pumping in order to achieve a good mixing and to avoid settling of insoluble components. Shearing can be further improved by employing baffles. Furthermore, the slurry obtained in step (B) may be subjected to a grinding treatment, for example, in a ball mill or stirred ball mill; such grinding treatment may lead to a better access of the polar solvent to a particulate lithium containing transition metal oxide material. Shearing and milling devices applied are typically sufficiently corrosion resistant; and they may be produced from similar materials and coatings as described above for the vessel.

In some embodiments of the present disclosure, the extraction has a duration in the range of from 20 minutes to 24 hours, such as 1 to 10 hours.

In some embodiments, the extraction is performed at least twice to reach an optimum recovery of lithium hydroxide or the lithium salt. Between each treatment a solid-liquid separation is performed. The obtained lithium salt solutions may be combined or treated separately to recover the solid lithium salts.

In sone embodiments of the present disclosure, step (B) including extraction and solid liquid separation is performed in batch mode.

In sone embodiments of the present disclosure, extraction and solid liquid separation are performed in continuous mode, e.g., in a cascade of stirred vessels and/or in a cascade of stirred vessel plus centrifuge.

In sone embodiments of the present disclosure, the polar solvent in present step (B) is an aqueous medium, and the ratio of the aqueous medium to material provided in step (A) is in the range of from 1:1 to 99:1, such as 5:1 to 20:1 by weight.

The alkaline earth hydroxide is chosen from hydroxides of Mg, Ca, Sr, and Ba. In some embodiments, the alkaline earth hydroxide is chosen from calcium hydroxide, barium hydroxide, and mixtures thereof. In some embodiments, the alkaline earth hydroxide is calcium hydroxide. The alkaline earth hydroxide used in present step (B) may be used as such, or may be added in the form of the oxide, or mixture of oxide and hydroxide, to form the alkaline earth hydroxide upon contact with a polar solvent chosen from protic solvents noted above.

The particulate material provided in step (A) comprises material obtained from lithium containing transition metal oxide material such as lithium ion battery waste after carrying out the preliminary step (i) of heating under inert or reducing conditions to a temperature in the range of 80° C. to 900° C., e.g., 200° C. to 850° C. or 200° C. to 800° C. Preliminary step (i) is typically carried out directly after discharging the lithium ion batteries, dismantling and/or shredding as explained in more detail below. In some applications shredding and/or dismantling is carried out after preliminary step (i). The lithium ion batteries used, and thus the particulate material provided in step (a), typically contains carbon, e.g., in the form of graphite.

Where elevated temperatures are noted, e.g., for treating the material in present step (i), exposure times, where indicated, define the total dwell time (synonymous with residence time) in the reactor or furnace, which has been heated to the elevated temperature; the temperature of the material should reach a temperature from the range given for at least a fraction of the dwell time.

C) LiOH Solution from Lithium Hydroxide Leaching

Carrying out the above-mentioned lithium hydroxide leaching, a solution is obtained which contains lithium in concentrations as described further above, typically as LiOH. Accordingly, the pH of this solution is highly basic, e.g., pH 13 or higher.

Within this LiOH solution several characteristic impurities are contained, such as, but not limited to, fluorine. Typical fluorine loadings are 500 ppm or more relative to dry LiOH, as described further above. In sone embodiments of the present disclosure, the fluorine concentration is in the range of from 0.05 wt. % to 5 wt. %, such as 0.1 wt. % to 4 wt. % or 0.1 wt. % to 2 wt. %, each relative to dry LiOH. The removal of this fluorine, which is described as anionic fluoride, is the subject matter of the present disclosure.

### D) Fluoride Removal by Adsorbents

The fluoride removal process is characterized in that the alkaline solution is contacted with a solid phase adsorbent chosen from alkaline earth salts and loaded resins as noted above.

Adsorption takes advantage of the tendency of one or more components of a liquid or gas to collect on the surface of a solid. This tendency can be leveraged to remove solutes from a liquid or gas or to separate components that have different affinities for the solid. The process may be either waste treatment or the purification of valuable components of a feed stream. In an adsorption process, the solid is called the adsorbent and the solute is known as the adsorbate.

Commercial adsorbents, which are highly porous, with pore surface areas ranging from about 100 m²/g to 1,200 m²/g are useful. The large surface area allows a large amount of adsorption relative to the weight of the adsorbent, well in excess of its own weight in some cases. Moreover, solute levels in the treated fluid can be reduced to a fraction of a ppm.

The affinity of a fluid component for a particular adsorbent depends on molecular characteristics such as size, shape polarity, the partial pressure or concentration in the fluid, and the system temperature (J. Wilcox, Carbon Capture, New York: Springer Science+Business Media, LLC, 2012). The strength of the surface forces depends on the nature of both the solid and the adsorbate. If the forces are relative weak, involving only van der Waals interactions, also known as dispersion-repulsion forces and electrostatic forces, which are sourced from polarization, dipole, quadrupole and higher-pole interactions, we have what is called physical adsorption or physisorption. The van der Waals forces are present in all systems, but electrostatic interactions are only present in systems that contain charge, and sorbents surface with functional groups and surface defects. If the interaction forces are strong, involving a significant degree of electron transfer, we have chemisorption. Generally, physisorption occurs when the heat of adsorption is less than approximately 10-15 kcal/mol, while chemisorption occurs when the heat of adsorption is greater than 15 kcal/mol. These are general rules, however, and exceptions do exist. Physisorption is a rapid non-activated and reversible process, and although polarization is possible, no electron transfer occurs. Chemisorption is a slower process than physisorption due to the electron transfer leading to bonding between the adsorbate and surface and the required activation barrier that has to be overcome for the formation of the bound complex.

Ion exchange generally is defined as a reversible chemical interaction between a solid and a fluid, wherein selected ions are interchanged between the solid and fluid. An exemplary ion exchange process includes an exchange process wherein a fluid passes through a bed of porous resin beads having charged mobile cations or anions, such as hydrogen or hydroxide ions, which are available for exchange with metal ions or anions present in the fluid. The ion exchange resin readily exchanges hydrogen ions for the metal ions, or hydroxide ions for other anions, present in the fluid as the fluid passes through the bed. In time, the number of hydrogen or hydroxide ions available for exchange with metal ions or other anions diminishes.

Eventually, the resin becomes exhausted and cannot perform any further ion exchange (i.e., all available exchange sites are occupied). However, the resin can be regenerated. Regeneration is accomplished using a regenerant solution, which, in the case of a cation exchange resin, comprises an acid, i.e., a large excess of hydrogen ions, that is passed over the ion exchange beads and drives the collected ions from the resin, thereby converting the ion exchange resin back to its original form. An example of a cation exchange process is the purification/softening of tap water. In this process, weak acid ion exchange resins use carboxylic acid groups, in the anionic form e.g., sodium form, as the cation exchange site. The sodium ions are the charged mobile cations. Alkaline earth metals, such as calcium and magnesium, present in the tap water are exchanged for the sodium cations of the resin as the water passes through a bed of the ion exchange resin beads.

Removal of calcium and magnesium ions from water in exchange for sodium ions via weak acid cation exchange resins is not limited to the water purification/softening applications, but also includes the softening of fluids, such as clay suspensions, sugar syrups, and blood, thereby rendering the fluids more amenable to further processing. When the exchange capabilities of the ion exchange resin are exhausted, a weak acid can be used to regenerate the acid form of the resin, followed by conversion of the acid form of the resin to the sodium form with dilute sodium hydroxide. Similarly, an anion exchange resin containing anionic functional groups removes anions, like nitrate and sulfate, from solution. Anion exchange resins also can be regenerated with a sodium hydroxide solution, for example. The reversibility of the ion exchange process permits repeated and extended use of an ion exchange resin before replacement of the resin is necessary.

The useful life of an ion exchange resin is related to several factors including, but not limited to, the amount of swelling and shrinkage experienced during the ion exchange and regeneration processes, and the amount of oxidizers present in a fluid passed through the resin bed.

Cation exchange resins typically are highly crosslinked polymers containing carboxylic, phenolic, phosphonic, and/or sulfonic groups, and roughly an equivalent amount of mobile exchangeable cations. Anion exchange resins similarly are highly crosslinked polymers containing amino groups, and roughly an equivalent amount of mobile exchangeable anions. Suitable exchange resins, (a) possess a sufficient degree of crosslinking to render the resin insoluble and with low swelling; (b) possess sufficient hydrophilicity to permit diffusion of ions throughout its structure; (c) contain sufficient accessible mobile cation or anion exchange groups; (d) are chemically stable and resist degradation during normal use; and (e) are denser than water when swollen.

Description of beads production from powder: As mentioned above, commercial adsorbents are often highly porous, to offer a large surface area. Where such inorganic adsorbents (a) are not commercially available as porous beads but as powders, it may be advantageous to produce beads out of such powders.

Different ways to produce porous beads are described in the literature. The highest porosity is normally reached by agglomeration. In agglomeration equipment a binder solvent is added to the particles. The equipment can be any kind of mixer e.g., plough share mixer, free fall mixer, a fluidized bed or granulite plate. Another method is to make a suspension of powder and binder and dry it afterwards e.g., in a spray dryer, drum dryer. It is also possible to use press agglomeration e.g., in an extruder, pelletizer or tablet press. To achieve a porosity, it is preferable to prepare a sponge out of the powder or to add material which is afterwards removed e.g. by burning or dissolving.

To get a form-stable product and avoid disintegration of materials later in the application, the material can be afterwards sintered together e.g., by calcination.

Normally, porous beads are used for adsorption or ion-exchange. In most cases fixed bed adsorbents or ion-exchangers are used. But it is also possible to use fluidized-bed adsorbers or a pulsed bed adsorber. In case of a short lifetime of the adsorbents also moving beds or stirred vessels followed by a solid liquid separation is possible.

Under fixed bed operation, adsorption or ion-exchange columns may be arranged in series or parallel, and the fluid may be run in either upflow or downflow modes. In case the bed is saturated with adsorbate the adsorbent is exchanged or regenerated. If you have a series of columns the next bed in sequence then becomes the first bed, and the fresh bed is added in the final position.

In case of powder as adsorbent, the adsorption can be done in a stirred vessel batchwise followed by a liquid solid separation batchwise or continuously e.g. on a filter-press or by membrane separation. It is also possible to use a stirred vessel cascade in a continuous mode.

Treatment of exhausted inorganic adsorbents (a): Hydroxyapatite as well as Fluorapatite are used as raw materials in production of phosphorous containing fertilizers and also for phosphoric acid production. The apatite structure is dissolved by strong acids such as sulfuric or nitric acid, and the dissolved phosphate further processed to either phosphoric acid or phosphate salts. The fluoride containing apatite obtained from the claimed process is therefore a valuable raw material and can be introduced in these industrial processes.

The disclosure is further illustrated by the following examples.

### Abbreviations

In the context of the present disclosure, normal pressure means 1 atm or 1013 mbar. “Normal conditions” mean normal pressure and 20° C. NI stands for normal liter, liter at normal conditions (1 atm, 20° C.). PFA stands for perfluoroalkoxy polymer. ICP denotes inductively coupled plasma mass spectrometry, if not indicated otherwise. DI stands for de-ionized. BV stands for Bed Volumes (dimensionless unit; for example, a mini-column of 50 ml operated with 1-2 BV/h has a flow rate of 50-100 ml/h).

Percentages and amounts given in ppm (parts per million) refer to % or ppm by weight, and may also be specified as wt. % or wt.ppm, unless specifically defined otherwise. The expressions % by weight and wt % may be used interchangeably. Wherever mentioned, the terms “room temperature” and “ambient temperature” denote a temperature between about 18 and 25° C. XRD denotes powder x-ray investigation (radiation as indicated, typically Cu k-alpha1 radiation of 154 pm or Mo k-alpha1 of 71 pm).

### Description of Methods:

Particle size distribution measurements, including determination of D₅₀, were performed according to ISO 13320 EN:2009-10.

Elemental analysis of lithium, calcium, and manganese (performed inter alia for determining the Li, Ca, and Mn content of the particulate material provided in present step (a)): Reagents were deionized water, hydrochloric acid (36%), K₂CO₃—Na₂CO₃ mixture (dry), Na₂B₄O₇ (dry), hydrochloric acid 50 vol. % (1:1 mixture of deionized water and hydrochloric acid (36%)); all reagents are p.a. grade.

### Sample Preparation:

g of the particulate material for present step (a) (typically obtained from waste lithium ion batteries after performing the preliminary reduction step (i)) was weighed into a Pt crucible and a K₂CO₃—Na₂CO₃/Na₂B₄O₇ fusion digestion is applied: The sample was burned in an unshielded flame and subsequently completely ashed in a muffle furnace at 600° C. The remaining ash was mixed with K₂CO₃-Na₂CO₃/Na₂B₄O₇ (0.8 g/0.2 g) and melted until a clear melt is obtained. The cooled melting cake was dissolved in 30 mL of water, and 12 mL of 50 vol. % hydrochloric acid is added. The solution was filled up to a defined volume of 100 mL. This work up was repeated three times independently; additionally, a blank sample was prepared for reference purposes.

### Measurement:

Li, Ca, and Mn within the obtained solution was determined by optical emission spectroscopy using an inductively coupled plasma (ICP-OES). Instrument: ICP-OES Agilent 5100 SVDV; wavelengths: Li 670.783 nm; Ca 396.847 nm; Mn 257.610 nm; internal standard: Sc 361.383 nm; dilution factors: Li 100, Ca 10, Mn 100; calibration: external.

Elemental analysis of fluorine and fluoride was performed in accordance with standardized methods: DIN EN 14582:2016-12 with regard to the sample preparation for the overall fluorine content determination (waste samples); the detection method was an ion selective electrode measurement. DIN 38405-D4-2:1985-07 (water samples; digestion of inorganic solids with subsequent acid-supported distillation and fluoride determination using ion selective electrode).

Other metal impurities and phosphorous were determined analogously by elemental analysis using ICP-OES (inductively coupled plasma—optical emission spectroscopy) or ICP-MS (inductively coupled plasma—mass spectrometry). Total carbon was determined with a thermal conductivity detector after combustion.

Unless mentioned otherwise, the following standard method was employed for the testing of present adsorbents:

A mixture containing 50 to 100 g of the aqueous alkaline solution to be treated (typically LiOH leaching filtrate with Li concentrations from the range 0.5 wt.-%-3.4 wt. %) and 0.1 wt. % to 10 wt. % of the adsorbent was prepared in an Erlenmeyer flask, or in a glass or HDPE bottle. All percentages were based on the total weight of the mixture. The mixture was shaken for at least 24 h (maximum of 96 h) at room temperature or at 60° C. The adsorbent was removed by filtration and the filtrate is analyzed using ISE (ion selective electrode) for fluoride and ICP-OES (optical emission spectroscopy with inductively coupled plasma) or AAS (atomic adsorption spectroscopy) for alkaline metal such as Li, and other metals. By comparing the fluoride content to a blind sample, the fluoride loading on the solid was calculated

### Educt 1: Synthetic Educt Sample

An amount of 200 g simulated spent battery scrap containing
78.8 g spent cathode active material containing nickel, cobalt and manganese in similar molar amounts, approximate formula Li(Ni_{0.34}Co_{0.33}Mn_{0.33})O₂,
62.2 of organic carbon in the form of graphite and soot
47.0 g of organic electrolyte mixture (containing LiPF6)
7.4 g polyvinylidene fluoride as binder,
2.4 g aluminum powder,
0.2 g iron powder,
2.0 g copper metal

was placed into a 500 mL quartz round bottom flask and attached to a rotary evaporator in a way that the flask was immersed in an oven. Within 4.5 hours, the rotating flask was heated to 800° C. in the course of 2 hours under a flow of argon (20 I/h) and held at this temperature for 1 hour under a flow of dry air (20 I/h) before cooling down to ambient temperature. An amount of 173.3 g heat treated material was obtained comprising a phase composition of Ni/Co-alloy, iron manganese oxide, Li₂CO₃, LiF, and graphite.

Educt 1a: Providing a Reduced Mass from Waste Lithium Ion Batteries

An amount of ˜1 t mechanically treated battery scrap containing spent cathode active material containing nickel, cobalt and manganese, organic carbon in the form of graphite and soot and residual electrolyte, and further impurities inter alia comprising fluorine compounds, phosphorous and calcium was treated to obtain a reduced mass according to the process described in Jia Li et al., Journal of Hazardous Materials 302 (2016) 97-104. The atmosphere within the roasting system was air whose oxygen reacts with the carbon in the battery scrap to form carbon monoxide. The treatment temperature was 800° C.

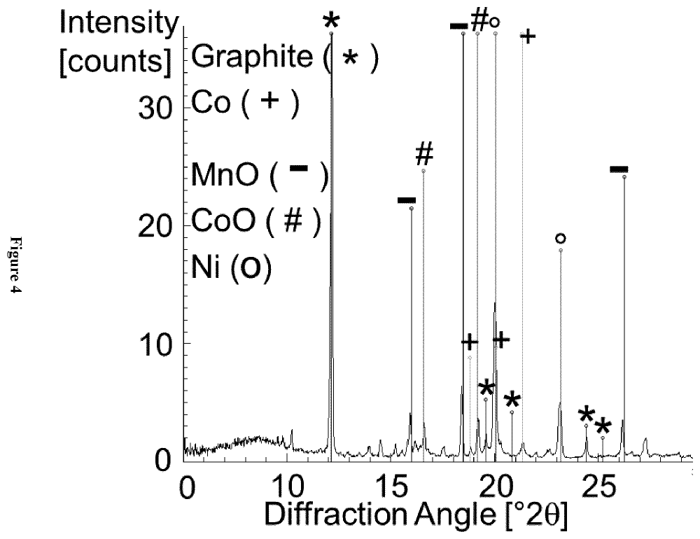

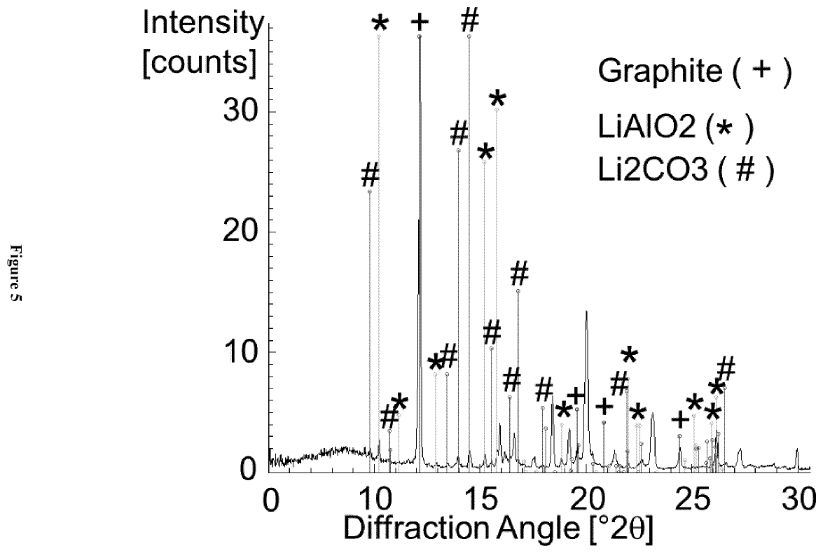

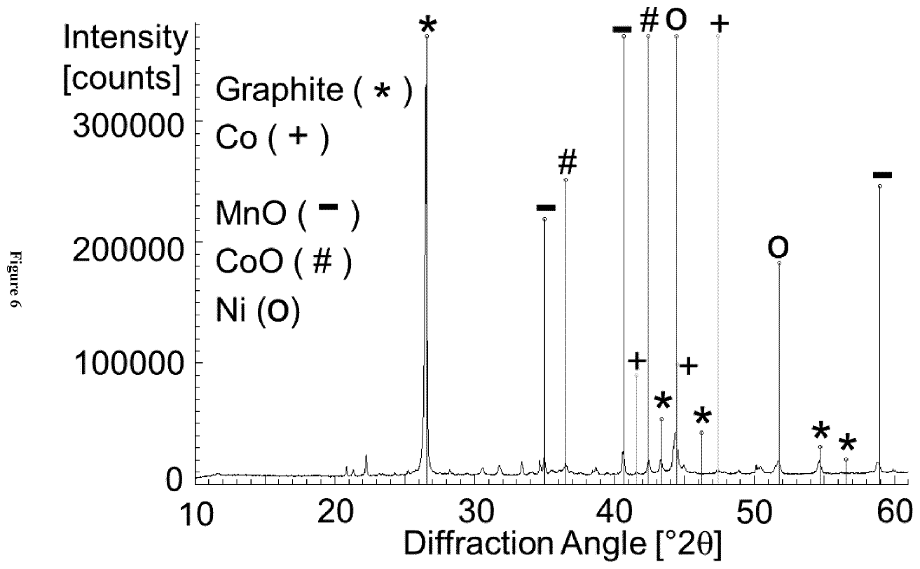

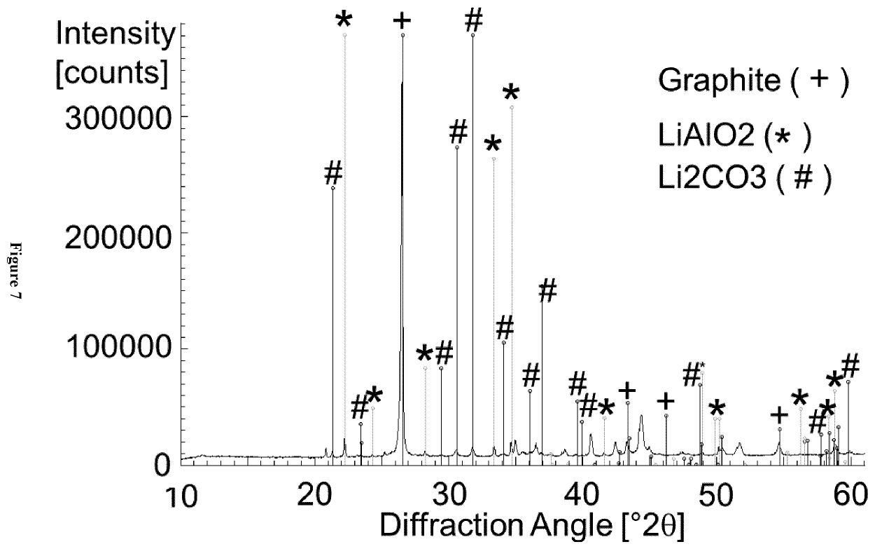

After reaction and cool down to ambient temperature, the heat-treated material was recovered from the furnace, mechanically treated to obtain a particulate material, and analyzed by means of X-ray powder diffraction (FIGS. 4 and 5: Mo Ka radiation, FIGS. 6 and 7: Cu Ka radiation), elemental analysis (Table 1) and particle size distribution (Table 2).

The Li content was 3.6 wt.-%, which acts as reference for all further leaching examples (see below). Fluorine was mainly represented as inorganic fluoride (88%). Particle sizes were well below 1 mm; D₅₀ was determined to be 17.36 μm.

Comparing the obtained XRD pattern with calculated reference patterns of Ni (which is identical with that one of CoxNi1-x, x=0-0.6), Co, Li₂CO₃ and LiAlO₂, it can be concluded that Ni was exclusively present as metallic phase, either as pure Ni or as an alloy in combination with Co. For clarity, this result was confirmed by applying two different radiation sources. The presence of metallic nickel was supported by the qualitative observation that the whole sample shows typical ferromagnetic behavior when it gets in touch with a permanent magnetic material. As lithium salts, Li₂CO₃ as well as LiAlO₂ were clearly identified by their characteristic diffraction pattern.

The composition of the black powder (PM) obtained was shown in Table 1.

TABLE 1
Composition of reduced black powder (PM)

| | |
|---|---|
| F (ionic | 2.6 g [i.e. 0.14 mol]/100 g |
| F thereof) | (2.3 g [i.e. 0.12 mol]/100 g) |
| C (inorganic | 31.3 g/100 g (1.2 g/100 g) |
| C thereof) | |
| Ca | 0.16 g [i.e. 0.004 mol]/100 g |
| Co | 9.5 g/100 g |
| Cu | 3.4 g/100 g |
| Li | 3.6 g/100 g |
| Mn | 5.8 g/100 g |
| Ni | 4.8 g/100 g |
| P | 0.36 g/100 g |

TABLE 2
Results on particle size distribution measurement of reduced
mass from waste lithium ion batteries after heat treatment.

| D₁₀ [μm] | D₅₀ [μm] | D₈₀ [μm] | D₉₀ [μm] |
|---|---|---|---|
| 3.46 | 17.36 | 33.86 | 48.92 |

Educt 2: Leaching with Ca(OH)₂

An amount of 5 g of the above-mentioned reduced battery scrap material (obtained as shown in Example 1a) was filled in a PFA flask and mixed with 5, 1.5, 1.0 and 0.5 g of solid Ca(OH)₂, respectively. 200 g of water were added with stirring, and the whole mixture was refluxed for 4 hours.

After 4 hours, the solid content was filtered off and filtrate samples are taken and analyzed with regard to Li, F, carbonate, OH, and Ca. Results were compiled in the below Table 3.

TABLE 3
Analyzed filtrates after Li leaching with Ca(OH)₂.

| Amount of | Lithium | Fluoride | Li leaching |
|---|---|---|---|
| Ca(OH)₂ | content | content | efficiency |
| [g] | [mg] | [mg] | [%] |
| 0.5 | 144 | 46 | 80 |
| 1.0 | 154 | 12 | 84 |
| 1.5 | 156 | 4 | 86 |
| 5 | 162 | 4 | 90 |

Educt 2a: Leaching with Ca(OH)₂, addition of solids to liquid

Example 2 was repeated except that 5 g of the black powder obtained as shown in Example 1a, and the designated amount of solid Ca(OH)₂, were added simultaneously to 200 g of water with stirring. Results were analogous to those reported in Table 2.

### Educt 3: Higher Solid Content

An amount of 10, 20 and 30 g, respectively, of the particulate material (PM) described in Example 1a was filled in a PFA flask and mixed with solid Ca(OH)₂ in a fixed weight ratio of PM: Ca(OH)₂=3.3:1. Further treatment with addition of 200 g of water follows Example 2 except that each sample was refluxed for 6 hours. Results were shown in Table 4.

Based on these results, it was concluded that the efficiency of the present leaching process was not affected by the PM solid content.

TABLE 4
Analyzed filtrates after Li leaching with Ca(OH)₂.

| Amount of | Lithium | Fluoride | Li |
|---|---|---|---|
| material from | content | content | leaching |
| example 1 | [mg] | [mg] | efficiency |
| 10 g | 322 | 10 | 89% |
| 20 g | 624 | 20 | 86% |
| 30 g | 987 | 30 | 91% |

### Educt 4: Variation of Parameters

Following the procedure of Example 2a, solid Ca(OH)₂ and the particulate material (PM) described in Example 1a was added with stirring (3 stages cross-beam stirrer, 60 mm diameter) to 836.8 g of pre-heated water in a glass reactor with baffles. The stirring was continued at constant temperature for the time period (t) indicated in Table 5, after which the solid was filtered off and filtrate samples are analyzed. Amounts of Ca(OH)₂ and PM, temperatures, stirring parameters, and analysis results (%=g found in 100 g of filtrate) were also compiled in Table 5.

TABLE 5

| | | | | recovered |
|---|---|---|---|---|
| Sample | t [h] | Li [%] | F⁻ [%] | Li [%] |
| 125.5 g PM, | 0 | | | |
| 37.7 g Ca(OH)₂ | 2 | 0.28 | 0.024 | 55% |
| T = 70° C., | 3 | 0.28 | 0.022 | 55% |
| stir with 525 rpm | 4 | 0.30 | 0.021 | 59% |
| (0.85 W/kg) | 6 | 0.33 | 0.014 | 65% |
| | 24 | 0.41 | 0.007 | 80% |
| 125.5 g PM, | 0 | | | |
| 37.7 g Ca(OH)₂ | 2 | 0.41 | 0.016 | 80% |
| T = 95° C., | 3 | 0.43 | 0.015 | 84% |
| stir with 525 rpm | 4 | 0.44 | 0.015 | 86% |
| (0.85 W/kg) | 6 | 0.47 | 0.014 | 92% |
| | 24 | 0.48 | 0.014 | 94% |
| 125.5 g PM, | 0 | | | |
| 37.7 g Ca(OH)₂ | 2 | 0.42 | 0.014 | 82% |
| T = 98° C., | 3 | 0.43 | 0.013 | 84% |
| stir with 950 rpm | 4 | 0.45 | 0.013 | 88% |
| (5 W/kg) | 6 | 0.45 | 0.013 | 88% |
| | 24 | 0.48 | 0.016 | 94% |
| 167.4 g PM, | 0 | | | |
| 50.2 g Ca(OH)₂ | 2 | 0.49 | 0.019 | 72% |
| T = 98° C., | 3 | 0.53 | 0.018 | 78% |
| stir with 600 rpm | 4 | 0.54 | 0.018 | 79% |
| (1.3 W/kg) | 6 | 0.55 | 0.018 | 81% |
| | 24 | 0.64 | 0.029 | 94% |

Educt 5: Solid LiOH from Leached Lithium Filtrate

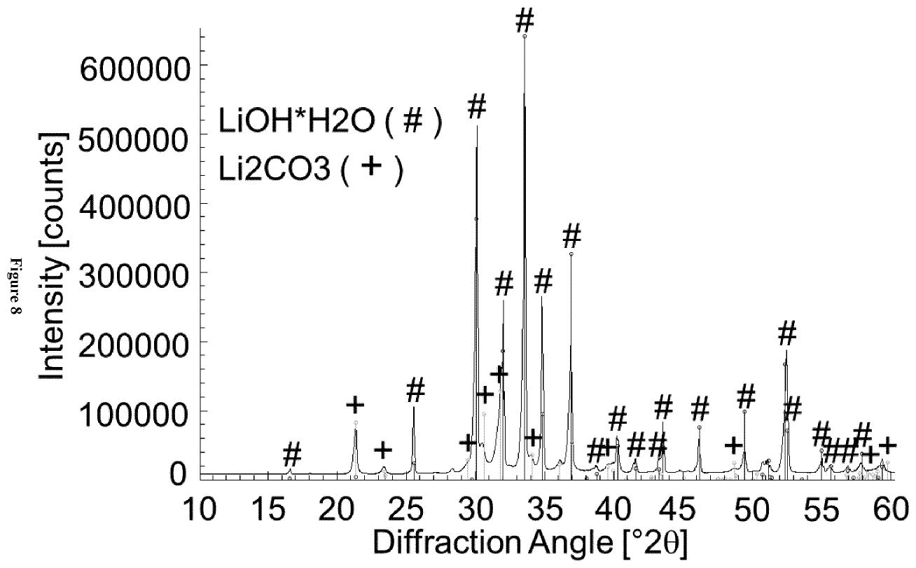

A filtrate obtained from a process according to Example 2 was further treated to yield solid LiOH as monohydrate: 1 L of a filtrate containing 0.21 wt. % lithium was concentrated by evaporation (40° C., 42 mbar) and finally dried applying 40° C. and a constant flow of nitrogen for 24 h. FIG. 8 shows the obtained LiOH monohydrate with minor impurities of Li₂CO₃. The latter was due to contact with air during almost all process steps. Next to carbon-based impurities, elemental analysis revealed as main impurities (>200 ppm) F, Na, Ca, K and Cl and minor impurities (<200 ppm) of Al and Zn.

### Examples for Fluoride Extraction (Batch Processes)

A mixture of 0.1 wt. % to 10 wt. % of adsorbent and a LiOH leaching filtrate (50-100 g) with Li concentrations of 0.5 wt. % (diluted filtrate) or 3.4 wt. % (concentrated filtrate), as obtainable in accordance with the above educt examples, was prepared in an Erlenmeyer flask. Alternatively, a glass or a HDPE bottle can be used. The mixture was shaken for 48 h (in case of inorganic adsorbents) or 24 h (in case of resin adsorbents) at the temperature indicated in the below Tables 6 or 7. The adsorbent was subsequently removed by filtration and the filtrate was analyzed using ISE (ion selective electrode) for fluoride and ICP-OES (optical emission spectroscopy with inductively coupled plasma) or AAS (atomic adsorption spectroscopy) for Li and other metals. By comparing the fluoride content to a blind sample (i.e., sample without the addition of adsorbent), the fluoride loading on the solid was calculated.

Results obtained using alkaline earth salt adsorbents were combined in the following Tables 6a and 6b; results obtained using ion exchange resins loaded with 3-valent cations were combined in the following Tables 7 (a and b). Comparative tests were performed using another type of mineral adsorbent (La(OH₃) and a resin loaded with 4-valent Zr rather than present 3-valent cations.

The cation binding ion exchange resins were loaded with the cations indicated by the following procedure: A mini-column was set up and filled with an appropriate volume of resin in delivery form. The resin was firstly thoroughly washed with DI-water to eliminate possible contaminants, fouling and debris.

The resin was doped passing through the resin bed at slow velocity (normally 1-2 BV/h or higher) an aqueous solution containing a soluble salt of the desired metal e.g., aluminium(III) chloride, lanthanum(III) chloride, zirconyl(IV) chloride etc.

A strong excess of salt in comparison with the active functional groups of the resin (normally expressed in eq/I or mol/I) was fed to the resin. The loading solution passed through the resin bed many times by use of a recirculation pump to increase contact time and thus increase the likelihood and effectiveness of the metal loading. The metal loading was generally performed at room temperature but may be also carried out at a different temperature.

The resin was then thoroughly rinsed with DI-water to wash away any possible residue of the doping solution. The metal loaded resin wass ready to use.

The ion exchange resins are based on a divinylbenzene crosslinked polystyrene matrix with bonding sites as follows:
Lewatit® Monoplus TP 207 and Lewatit® Monoplus TP 208 comprising chelating iminodiacetic acid groups (cation binding resin).
Lewatit® Monoplus TP 260 comprising chelating aminomethylphosphonic acid groups (cation binding resin).
The ion exchange resins of the type Lewatit® Monoplus are commercially available inter alia from Lanxess.

TABLE 6a
Loading of inorganic adsorbents (mg fluoride per g of adsorbent)
after 48 h contact with diluted filtrate at 20° C.

| | Starting conc. in | | Starting F | F conc. | Loading |
|---|---|---|---|---|---|
| | diluted LiOH | | content | after F | with |
| | filtrate [wt %] | | relative to | depletion | diluted |
| Adsorbent | Li | F | Li [ppm] | [wt %] | filtrate |
| (MgCO₃)₄Mg(OH)₂ · 5H₂O | 0.29 | 0.0099 | 34000 | 0.0031 | 3.5 |
| (Merck EMSURE ® p.a.) | | | | | |
| Magnesium Carbonate | 0.29 | 0.0022 | 7600 | 0.0019 | 0.2 |
| DC 90S/C (*) | | | | | |
| CaSO₄ (Acros Organics, | 0.29 | 0.0099 | 34000 | 0.0027 | 3.4 |
| purity ≥ 99%) | | | | | |
| MgO (**) | | | | | 0.5 |
| Magnesia 298 (***) | | | | | |
| MgO (****) | 0.29 | 0.0022 | 7600 | 0.0010 | 0.5 |
| MgCO₃ (#) | 0.29 | 0.0022 | 7600 | 0.0011 | 0.4 |
| Ca₅(PO₄)₃(OH) | | | | | |
| (Ca-Hydroxyapatite 1) | | | | | |
| Ca₅(PO₄)₃(OH) | 0.5 | 0.012 | 2400 | 0.0060 | 0.3 |
| (Ca-Hydroxyapatite 2) | | | | | |
| La(OH)₃ (Sigma-Aldrich; | 0.29 | 0.0150 | 52000 | 0.0150 | 0.0 |
| Comparison) | | | | | |

TABLE 6b
Loading of inorganic adsorbents (mg fluoride per g of adsorbent) after 48 h contact with
concentrated filtrate at the temperature (T) indicated

| | | Starting conc. | | Starting F | | Loading |
|---|---|---|---|---|---|---|
| | | in conc. LiOH | | content | F conc. after | with |
| | T | filtrate [wt %] | | relative to Li | F depletion | conc. |
| Adsorbent | [° C.] | Li | F | [ppm] | [wt %] | filtrate |
| Magnesium Carbonate | 20 | 2.3 | 0.0370 | 16000 | 0.0350 | 0.6 |
| DC 90S/C (*) | | | | | | |
| CaSO₄ (Acros Organics, | 20 | 1.9 | 0.0420 | 22000 | 0.0330 | 1.8 |
| purity ≥99%) | | | | | | |
| MgO (**) | 20 | | | | | 1.5 |
| Magnesia 298 (***) | 20 | 1.7 | 0.0350 | 21000 | 0.0300 | 1.2 |
| MgO (****) | 20 | 1.7 | 0.0360 | 21000 | 0.0280 | 1.5 |
| MgCO₃ (#) | 20 | 2.3 | 0.0370 | 16000 | 0.0260 | 0.7 |
| Ca₅(PO₄)₃(OH) | 20 | 1.9 | 0.0420 | 22000 | 0.0030 | 2.5 |
| (Ca-Hydroxyapatite 1) | | | | | | |
| Ca₅(PO₄)₃(OH) | 20 | 1.9 | 0.0420 | 22000 | 0.0220 | 0.6 |
| (Ca-Hydroxyapatite 2) | | | | | | |
| Ca₅(PO₄)₃(OH) | 20 | 2.9 | 0.0270 | 14000 | 0.0160 | 1.2 |
| (Ca-Hydroxyapatite 3) | | | | | | |
| Ca₅(PO₄)₃(OH) | 60 | 2.7 | 0.0250 | 9300 | 0.0010 | 3.6 |
| (Ca-Hydroxyapatite 3) | | | | | | |
| Ca₅(PO₄)₃(OH) | 20 | 2.8 | 0.0260 | 9300 | 0.0030 | 2.1 |
| (Ca-Hydroxyapatite 4) | | | | | | |
| Tricalcium phosphate | 20 | 2.8 | 0.0260 | 9300 | 0.0070 | 2.1 |
| (Solvay, >99%) | | | | | | |

(*) Magnesium Carbonate DC 90S/C from Dr. Paul Lohmann GmbH; 4MgCO₃*Mg(OH)₂*5H₂O with 10% pregelatinized starch; coarse white granulate; particle size <0.8 mm approx 99.0%.
(**) MagGran ® 82660; MgO 98.8%; grain size 10%: 20-30 mesh, 52%: 30-60 mesh, 32%: 60-100 mesh, 6%: >100 mesh.
(***) MgO min. 99% fine white powder.
(****) MagGran ® 82600; MgO 100.0%; grain size 16%: 20-30 mesh, 66%: 30-60 mesh, 12%: 60-100 mesh, 5%: >100 mesh.
(#) MagGran ® MC 81820; particle size 250-600 micrometer approx. 85%.
Ca-Hydroxyapatite 1: tech. grade Aldrich powder (Lot# BCC5175); Purity >90%, D50 = 7.0 μm.
Ca-Hydroxyapatite 2: 99.9% Aldrich powder (Lot# MKCG0750); granule size = 0.5-2 mm.
Ca-Hydroxyapatite 3: tech. grade Aldrich powder (Lot# BCC5175), Purity >90%, granulated (0.5-2 mm)
Ca-Hydroxyapatite 4: 99% Solvay Capterall ® powder (D₅₀ = 22 μm)

TABLE 7a
Resins loaded with 3-valent metal ions (mg fluoride per g of adsorbent)
or 4-valent ion (mg Zr per g of adsorbent, comparison) after
24 h contact with diluted filtrate at room temperature

| | Starting | | | | |
|---|---|---|---|---|---|
| | concentration in | | F conc. | Starting F | |
| | diluted LiOH | | after F | content | |
| | filtrate [wt %] | | depletion | relative to | |
| Adsorbent | Li | F | [wt %] | Li [ppm] | Loading |
| Lewatit ® Monoplus | 0.49 | 0.0120 | 0.0030 | 24000 | 1.3 |
| TP 208 - La Doped | | | | | |
| Lewatit ® Monoplus | 0.29 | 0.0069 | 0.0062 | 24000 | 0.7 |
| TP 207 - Al Doped | | | | | |
| Lewatit ® Monoplus | 0.29 | 0.0069 | 0.0062 | 24000 | 0.9 |
| TP 208 - Al Doped | | | | | |
| Lewatit ® Monoplus | 0.29 | 0.0069 | 0.0063 | 24000 | 0.8 |
| TP 260 - Al Doped | | | | | |
| SunResin Seplite ® | 0.5 | 0.0120 | 0.0120 | 24000 | 0.0 |
| LSC 762 - Zr-Doped | | | | | |
| (Comparison) | | | | | |

TABLE 7b
Resins loaded with 3-valent metal ions (mg fluoride per g of adsorbent)
after 24 h contact with concentrated filtrate at room temperature

| | Starting | | | | |
|---|---|---|---|---|---|
| | concentration in | | F conc. | Starting F | |
| | concentrated LiOH | | after F | content | |
| | filtrate [wt %] | | depletion | relative to | |
| Adsorbent | Li | F | [wt %] | Li [ppm] | Loading |
| Lewatit ® Monoplus | 1.6 | 0.0320 | 24000 | 0.0310 | 1.0 |
| TP 208 - La Doped | | | | | |
| Lewatit ® Monoplus | | | | | |
| TP 207 - Al Doped | | | | | |
| Lewatit ® Monoplus | | | | | |
| TP 208 - Al Doped | | | | | |
| Lewatit ® Monoplus | | | | | |
| TP 260 - Al Doped | | | | | |

### Fluoride Depletion in Columns

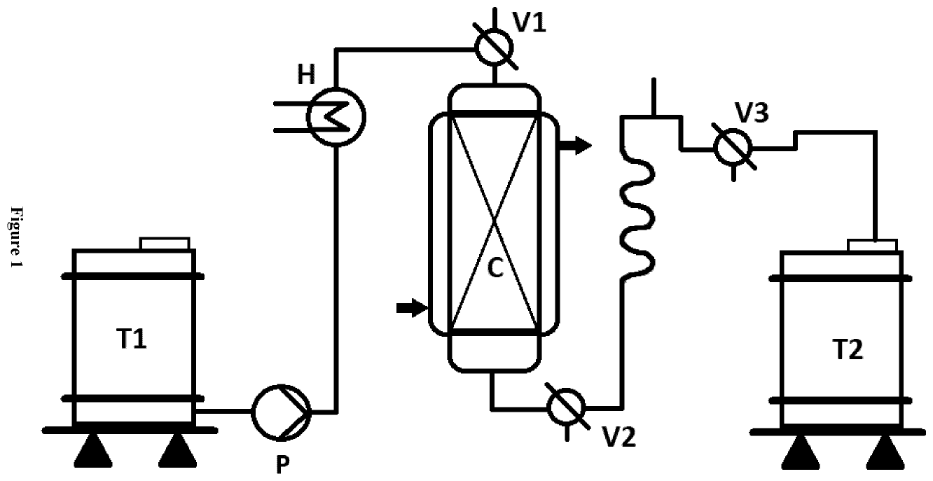

Experimental setup: A column experiment simulates the application of a filter column where the feed stream is continuously run over a fixed filter bed. The standard experimental setup is shown in FIG. 1.

The feed solution is stored in a tank (T1). The tank is installed on a balance so that the consumption of solution can be easily determined by measuring the weight. A pump (P) pumps the feed solution in a continuous volumetric flow rate into the head of the ion exchange column (C). The feed stream can be heated up by passing it over a heat exchanger (H) in between the storage tank (T1) and the column (C). The column (C) is provided with heating jacked. An appropriate insulation of the column (C) and of the heat exchanger (H) and the related tubes is recommended.

The three-way valve (V1) at the head of the column is used to remove gas bubbles from the column head. It can also be used to feed regenerants or rinse water in further steps of processing.

At the column outlet there is a second three-way valve (V2), a siphon (S) and a third three-way valve (V3). Valve V2 is used to drain liquid out of the column, when required. It also serves as in- or outlet for regeneration, rinse or backflush operations.

The siphon (S) is connected with V2 and V3 via flexible rubber tubes. By changing its position, the filling level of water inside the column can be adjusted: The height of the siphon controls the height of the liquid level in the column. It also makes sure, that the column will never run dry by suction effects deriving from the outlet flow.

Behind the siphon the product flows via the valve V3 towards the purified product collection tank T2. Valve 3 can be used for sampling purpose.

The balance below T2 allows for measurement of the mass of filtered product.

In the setup given in FIG. 1, the column is operated in downflow mode. The column can be also operated in upflow direction. In this case the position of the feed and the effluent tubes is changed accordingly. Also, it may not be required to use a siphon.

Online-measurement probes are installed, such as probes to measure pH, temperature, and electrical conductivity (LF; λ). Online-monitoring of both, feed and effluent streams is useful to identify parameters which later on can be used for process control purposes. An automatic sampler is useful to allow the column experiment run over night and therefore helps to monitor breakthrough curves with cycle times longer than one day. A dynamic adsorption process within a running test when operating capacity is the target parameter aimed to be determined should not be stopped. A stop disturbs the buildup of concentration profiles inside the column and also within the pores of the resin beads. Therefore, the influence of kinetic resistance is not depicted correctly in a filtration test that is interrupted.

In case of regeneration and rinse more modifications have to be undertaken: additional containers to store fresh regenerants and rinse water are installed as well as containers to collect the spent regenerants and spent rinse waters.

Pumps to control the transportation of these liquids are installed too. The regeneration can be

carried out counter-currently or co-currently compared to the direction of flow applied in the service phase.

To allow running two columns in alternating mode (lead lag) whereby one is in operation and the other one in regeneration an even more sophisticating setup is required.

The filtration experiment is not to be stopped when the first signals of a breakthrough are seen. It is carried out all through the breakthrough phase. This proofs whether the breakthrough indeed happened and that it is not just a fake caused by one or two higher concentration values. The full shape of the breakthrough curve allows conclusions on kinetic and/or dumping effects. To allow measuring a full break through curve the volume of feed solution is prepared with in minimum 50% excess based on the filtrate volume calculated (estimated) for the breakthrough point.

Column Operation: The column (ID 30 mm, H 500 mm) is filled with the defined amount of adsorbent (e.g. resin) volume e.g. 340 ml=1 BV. The column must not be empty when filling the resin, but half of the column volume must be already filled with DI-water.

Before feeding the column with the original process solution several BV of distilled water are run through it, an example but not only 5 BV/h until pH is ca. 7 or LF is not higher than 3 mS/cm.

After the water test run, the column is fed with product stream and operating time is running. For example, LiOH solution is pumped at room temperature or higher (e.g., 60° C.) and 340 ml/h (1 BV/h) through the column in upflow mode. Specific velocities can range normally between 0,1 BV/h up to 100 BV/h. Elevated pressure may be applied, especially when using inorganic adsorbents, but compacting of the adsorbent is to be avoided.

Samples of the column effluent are withdrawn in sequences according to the decided plan, inter alia considering the conductivity of the outlet:
For λ≤100 mS/cm: collect and dispose of diluted flow separately;
For λ>100 mS/cm: collect one fraction every BV;
Stop the loading after 48 BV.

Any other combination of check and stops criteria can be used according to necessity.

After loading the adsorbent, the bed is rinsed with several BV of distilled water, e.g., 2 BV/h until pH is ca. 7 or LF is not higher than 3 mS/cm to wash out rest traces of the LiOH product. Also during the rinse step, samples of the column effluent are withdrawn in sequences according to the decided plan, ad example (but not only) considering the conductivity of the outlet:
For λ≥3 mS/cm: collect one fraction every BV;
Stop the rinsing when λ<3 mS/cm.

During the regeneration step (if needed), an alkaline solution (an example but not only a NaOH solution with a concentration ranging e.g. from 4 wt.-% to 20 wt.-%) is pumped through the column, e.g., at 2 BV/h. Regeneration can be carried out co-currently or counter currently at room temperature or higher temperature. During the regeneration step, samples of the column effluent are withdrawn in sequences according to the decided plan, advantageously considering the pH of the outlet:
For pH<12: collect and dispose of diluted flow separately;
For pH>12: collect one fraction every BV;
Stop the regeneration after 18 BV.

After the regeneration step, the bed is rinsed with several BV of distilled water, e.g., 2 BV/h until pH is ca. 7 or LF is not higher than 3 mS/cm to wash out rest traces of the NaOH solution.

Subsequently, another loading cycle is run. The adsorbent is either regenerated, or is removed from the column and exchanged with fresh adsorbent.

The collected samples are analyzed accordingly for the target components, and evaluations of the loading experiment and regeneration experiment are made.

This disclosure is now described with reference to the following embodiments, and it is to be understood that the disclosure is not limited to these embodiments and is capable of other embodiments and of being practiced or being carried out in various other ways.
1. A process for extracting fluoride from a solution comprising:
contacting the solution with a solid phase adsorbent chosen from
a) alkaline earth salts comprising carbonate anions, oxo anions, sulphate anions, or phosphate anions, and alkaline earth salts comprising a mixture of such anions or a mixture of such anions with hydroxyl anions, and
b) cation binding resins loaded with one or more 3-valent cations, chosen from 3-valent cations of Al, Ga, In, Fe, Cr, Sc, Y, La, and lanthanoides, and
wherein the solution comprises more than 0.1 mol of alkaline hydroxide and/or alcoholate per liter dissolved in a polar solvent chosen from water, lower alcohols, and mixtures thereof.
2. The process according to embodiment 1, wherein the solution is an aqueous alkaline solution.
3. The process according to embodiment 1 or 2, wherein the solid phase adsorbent is chosen from:
a) alkaline earth salts comprising calcium phosphates, calcium hydroxyphosphates, calcium sulphate, magnesium carbonate, magnesium oxide, calcium hydroxyapatite, and/or tricalcium phosphate, and
b) cation binding resins loaded with one or more 3-valent cations chosen from 3-valent cations of aluminum and lanthanum.
4. The process according to embodiment 1 or 3, wherein the solution is an aqueous and/or methanolic alkaline solution comprising more than 0.1 mol of alkaline hydroxide and/or methanolate per liter and 50% or more by weight of the total liquid consists of water and/or methanol.
The process according to any one of the foregoing embodiments, wherein the alkaline hydroxide is lithium hydroxide, and wherein the alkaline alcoholate is lithium alcoholate, such as methanolate.
6 The process according to any one of the foregoing embodiments, wherein the solution of alkaline hydroxide and/or alcoholate comprises 0.2 mol or more, or 0.35 mol or more, of alkaline hydroxide and/or alcoholate per liter in dissolved state.
7. The process according to any one of the foregoing embodiments, wherein contacting of the alkaline solution liquid with the solid phase adsorbent is carried out at a pressure between bar and 100 bar, and at a temperature above the melting temperature of the liquid and below the boiling point of the liquid under the actual pressure conditions, or from 0° C. to 150° C.
8. The process according to any one of the foregoing embodiments, wherein the solid phase adsorbent (a) is powdery or granulated material, or a material in the form of beads or pellets with diameter (D₅₀) from 10 micrometer to 10 mm, or from 100 micrometer to 5 mm.
9. A process for producing a high purity lithium hydroxide from a lithium material, the process comprising:
treating the lithium material to form a water-soluble lithium salt solution, wherein the lithium material is chosen from brines, ores, slags, and flue ashes and the lithium material forms an alkaline solution comprising more than 121 wt. ppm of ionic fluoride with respect to the lithium content of the solution, optionally transforming the lithium salt into lithium hydroxide, and
purifying the lithium hydroxide according to any one of embodiments 1 to 8.
10. The process according to embodiment 9, wherein treating comprises acid leaching, and wherein the lithium salt is subsequently transformed into lithium hydroxide by dissolving in a polar solvent to form a solution comprising more than 121 wt.ppm of ionic fluoride with respect to the weight of lithium in the solution.
11. The process according to embodiment 9, wherein treating to form the water-soluble lithium salt comprises a thermal treatment process followed by a lithium extraction process using a polar solvent, optionally in the presence of alkaline earth oxides or hydroxides, and the water-soluble lithium salt is lithium carbonate, lithium bicarbonate, and/or lithium hydroxide.
12. A process for producing a high purity lithium hydroxide from a lithium material, the process comprising:
treating the lithium material to form a water-soluble lithium salt solution, wherein the lithium material is chosen from lithium-ion-batteries or parts of lithium-ion-batteries or production scraps from the production of lithium-ion-batteries or cells or the electrode active materials and the lithium material forms an alkaline solution comprising more than 121 wt.ppm of ionic fluoride with respect to the lithium content of the solution,
transforming the lithium salt into lithium hydroxide,
dissolving and purifying the lithium hydroxide solution according to any one of embodiments 1 to 8.
13. The process according to embodiment 12, wherein treating comprises an acid leaching process and the lithium salt is the salt of this acid anion and the lithium salt is subsequently transformed into lithium hydroxide.
14. A process for producing a high purity lithium hydroxide from lithium containing wastewater, the process comprising:
i) concentrating the lithium content of the wastewater or precipitating or extracting or adsorbing the lithium ions, wherein the wastewater comprises more than 121 ppm of ionic fluoride with respect to the lithium content of the wastewater; and
ii) transforming the concentrated lithium salt from i) into a solution of lithium hydroxide in a polar solvent, and
iii) purifying the lithium hydroxide according to any one of embodiments 1 to 8.

1. A process for extracting fluoride from a solution comprising:
contacting the solution with a solid phase adsorbent chosen from
a) alkaline earth salts comprising carbonate anions, oxo anions, sulphate anions, or phosphate anions, and alkaline earth salts comprising a mixture of such anions or a mixture of such anions with hydroxyl anions, and
b) cation binding resins loaded with one or more 3-valent cations, chosen from 3-valent cations of Al, Ga, In, Fe, Cr, Sc, Y, La, and lanthanoides, and
wherein the solution comprises more than 0.1 mol of alkaline hydroxide and/or alcoholate per liter dissolved in a polar solvent chosen from water, lower alcohols, and mixtures thereof.

2. The process according to claim 1, wherein the solution is an aqueous alkaline solution.

3. The process according to claim 1, wherein the solid phase adsorbent is chosen from:
a) alkaline earth salts comprising calcium phosphates, calcium hydroxyphosphates, calcium sulphate, magnesium carbonate, magnesium oxide, calcium hydroxyapatite, and/or tricalcium phosphate, and
b) cation binding resins loaded with one or more 3-valent cations chosen from 3-valent cations of aluminum and lanthanum.

4. The process according to claim 1, wherein the solution is an aqueous and/or methanolic alkaline solution comprising more than 0.1 mol of alkaline hydroxide and/or methanolate per liter and 50% or more by weight of the total liquid consists of water and/or methanol.

5. The process according to claim 1, wherein the alkaline hydroxide is lithium hydroxide, and wherein the alkaline alcoholate is lithium alcoholate, such as methanolate.

6. The process according to claim 1, wherein the solution of alkaline hydroxide and/or alcoholate comprises 0.2 mol or more, or 0.35 mol or more, of alkaline hydroxide and/or alcoholate per liter in dissolved state.

7. The process according to claim 1, wherein contacting of the solution with the solid phase adsorbent is carried out at a pressure between 0.1 bar and 100 bar, and at a temperature above the melting temperature of the solution and below the boiling point of the solution, or from 0° C. to 150° C.

8. The process according to claim 1, wherein the solid phase adsorbent (a) is powdery or granulated material, or a material in a form of beads or pellets with diameter (D₅₀) from 10 micrometer to 10 mm, or from 100 micrometer to 5 mm.

9. A process for producing a high purity lithium hydroxide from a lithium material, the process comprising:
treating the lithium material to form a water-soluble lithium salt solution, wherein the lithium material is chosen from brines, ores, slags, and flue ashes and the lithium material forms an alkaline solution comprising more than 121 wt. ppm of ionic fluoride with respect to a lithium content of the solution, optionally transforming the lithium salt into lithium hydroxide, and
purifying the lithium hydroxide according to claim 1.

10. The process according to claim 9, wherein treating comprises acid leaching, and wherein the lithium salt is subsequently transformed into lithium hydroxide by dissolving in a polar solvent to form a solution comprising more than 121 wt.ppm of ionic fluoride with respect to a weight of lithium in the solution.

11. The process according to claim 9, wherein treating to form the water-soluble lithium salt comprises a thermal treatment process followed by a lithium extraction process using a polar solvent, optionally in the presence of alkaline earth oxides or hydroxides, and the water-soluble lithium salt is lithium carbonate, lithium bicarbonate, and/or lithium hydroxide.

12. A process for producing a high purity lithium hydroxide from a lithium material, the process comprising:
treating the lithium material to form a water-soluble lithium salt solution, wherein the lithium material is chosen from lithium-ion-batteries or parts of lithium-ion-batteries or production scraps from the production of lithium-ion-batteries or cells or electrode active materials and the lithium material forms an alkaline solution comprising more than 121 wt.ppm of ionic fluoride with respect to a lithium content of the solution,
transforming the lithium salt into lithium hydroxide,
dissolving and purifying the lithium hydroxide solution according to claim 1.

13. The process according to claim 12, wherein treating comprises an acid leaching process and the lithium salt is the salt of this acid anion and the lithium salt is subsequently transformed into lithium hydroxide.

14. A process for producing a high purity lithium hydroxide from lithium containing wastewater, the process comprising:
i) concentrating the lithium content of the wastewater or precipitating or extracting or adsorbing the lithium ions, wherein the wastewater comprises more than 121 ppm of ionic fluoride with respect to a lithium content of the wastewater; and
ii) transforming the concentrated lithium from i) into a solution of lithium hydroxide in a polar solvent, and
iii) purifying the lithium hydroxide according to claim 1.
